(19) United States
(12) Patent Application Publication
(10) Pub. No.: US 2023/0233401 A1
(43) Pub. Date: Jul. 27, 2023

(54) MULTIFUNCTIONAL MASSAGER

(71) Applicant: Dong-Her Wu, CHANGHUA (TW)

(72) Inventor: Dong-Her Wu, CHANGHUA (TW)

(73) Assignee: Dong-Her Wu, CHANGHUA (TW)

(21) Appl. No.: 18/102,304

(22) Filed: Jan. 27, 2023

(30) Foreign Application Priority Data
Jan. 27, 2022 (TW) 111103710

(51) Int. Cl. A61H 15/00

(52) U.S. Cl. CPC A61H 15/0078; A61H 2015/005; A61H 2201/1215

(57) ABSTRACT

A multifunctional massager may include a frame body, and two first connecting bases are respectively formed at two ends of the frame body at symmetrical positions. Each of the two first connecting bases comprises three connecting bears at the inner surface thereof, and the connecting bears on the two first connecting bases are located at corresponding positions. An accommodating space is formed between the two first connecting bases. A massage member installed on the fame body between the two first connecting bases comprises a driving motor, a driving shaft, two connecting rods, and two driven shafts. The driving motor is connected to and drives the driving shaft, and two eccentric wheels are connected to two ends of the driving shaft. The two eccentric wheels are adapted to eccentrically drive the two connecting rods to carry out the reciprocating actions of internal pull and external push.

### FIELD OF THE INVENTION

The present invention relates to a massager and more particularly to a multifunctional massager for different sore parts of body.

### BACKGROUND OF THE INVENTION

It is easy for modern people to get pressure from work, and after a day's work, their body may have stiff, tight or sore due to walking, carrying heavy objects or sitting in poor posture for a long time. Therefore, the massager is often used to massage the sore parts of human body to achieve the purpose of relaxing the spirit and reducing stress of the user.

However, the conventional massager has following disadvantages: (i) although there are many kinds of massagers on the market, expecting large massage chairs, most of the small massagers can only provide the massage for single part, and when consumers need to massage different parts, they must purchase a different massagers to meet their individual massage needs; (ii) when the massagers are not in use, the consumer must find more spaces to store them; and (iii) although generally the price of small massagers may lower, buying different massagers is still a big burden for consumers. Therefore, there remains a need for a new and improved design for a multifunctional massager to overcome the problems presented above.

### SUMMARY OF THE INVENTION

The present invention provides a multifunctional massager having a frame body, and two first connecting bases are respectively formed at two ends of the frame body at symmetrical positions. Each of the two first connecting bases comprises three connecting bears at the inner surface thereof, and the connecting bears on the two first connecting bases are located at corresponding positions, and the distance between two adjacent connecting bears on the first connecting base is the same. An accommodating space is formed between the two first connecting bases. A massage member installed on the fame body between the two first connecting bases comprises a driving motor, a driving shaft, two connecting rods, and two driven shafts. The driving motor is connected to and drives the driving shaft, and two eccentric wheels are connected to two ends of the driving shaft, and the eccentric wheels are located at staggered positions, so that the rotation paths of the two eccentric wheels are opposite. The two connecting rods are respectively connected to the two eccentric wheels at the ends thereof, and the two connecting rods are respectively extended outward in staggered directions. Each of the two driven shafts has a plurality of massage heads secured thereon, and the two driven shafts parallel with the driving shaft are positioned at two sides of the driving shaft. Each of the two driven shafts is pivotally connected to a swing arm, and the two swing arms respectively and pivotally connected to the two connecting rods are respectively located at diagonal positions on the two driven shafts. The two ends of the driving shaft are respectively and pivotally connected to the two connecting bears at the middles of the two first connecting bases, and the two driven shafts are respectively connected between the two first connecting bases through the two corresponding connecting bears at two sides of the middle of connecting bears. When the driving motor drives and rotates the driving shaft, the two eccentric wheels are adapted to eccentrically drive the two connecting rods to carry out the reciprocating actions of internal pull and external push, and the two driven shafts are driven to have relative swing so as to achieve the massage purpose through the massage heads.

In one embodiment, the driving motor connected at one end of the driving shaft is located in the first connecting base at the position aligned with the connecting bearing at the middle.

In another embodiment, the driving motor connected at the middle of the driving shaft is secured on the frame body.

In still another embodiment, each of the two connecting rods comprises a rotary base installed at one end thereof, and each of the rotary bases has a connecting hole to securely connect to the eccentric wheel.

In a further embodiment, each of the massage heads comprises a second connecting base, and the massage head is secured on the driven shaft through the second connecting base; each of the two driven shafts is connected to the swing arm extended from the second connecting base at the end of the driven shaft, and the two swing arms are respectively located at diagonal positions on the two driven shafts.

In still a further embodiment, the two swing arms are respectively installed on the ends of the two driven shafts at diagonal positions.

In an advantageous embodiment, a cover is adapted to cover the frame body and the massage member.

Comparing with conventional multifunctional massager, the present invention is advantageous because: (i) the massager is small and portable, so that the user can change the way and position to massage the sore parts of the body without purchasing different kinds of massagers; and (ii) the driven shafts connecting to the massage heads are arranged at both sides of the driving shaft, and the reciprocating massage is carried out through the massage heads such that the two driven shafts have an appropriate distance therebetween to provide the preferable kneading from the massage heads.

### BRIEF DESCRIPTION OF THE DRAWINGS

FIG. 1 is a three-dimensional assembly view of a multifunctional massager of the present invention.

FIG. 2 is an exploded view of the multifunctional massager of the present invention.

FIG. 3 is a top view illustrating a plurality of massage heads are swinging outwardly on two driven shafts of the multifunctional massager of the present invention.

FIG. 4 is a sectional view illustrating the massage heads are swinging outwardly on the two driven shafts of the multifunctional massager of the present invention.

FIG. 5 is a sectional view illustrating the massage heads are swinging inwardly on the two driven shafts of the multifunctional massager of the present invention.

FIG. 6 is a top view illustrating the massage heads are swinging inwardly on the two driven shafts of the multifunctional massager of the present invention.

FIG. 7 is a top view of another embodiment of a driving motor of the multifunctional massager of the present invention.

FIG. 8 is an exploded view of the multifunctional massager of the present invention with a cover.

FIG. 9 is a three-dimensional assembly view of the multifunctional massager of the present invention with the cover.

FIG. 10 is a schematic view illustrating the multifunctional massager of the present invention massages the user's lower leg.

FIG. 11 is a schematic view illustrating the multifunctional massager of the present invention massages the user's lower leg and posterior of knee.

FIG. 12 is a schematic view illustrating the multifunctional massager of the present invention massages the user's thigh and hip.

FIG. 13 is a schematic view illustrating the multifunctional massager of the present invention massages the user's waist and lower back.

FIG. 14 is a schematic view illustrating the multifunctional massager of the present invention massages the user's shoulder, neck and upper back.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

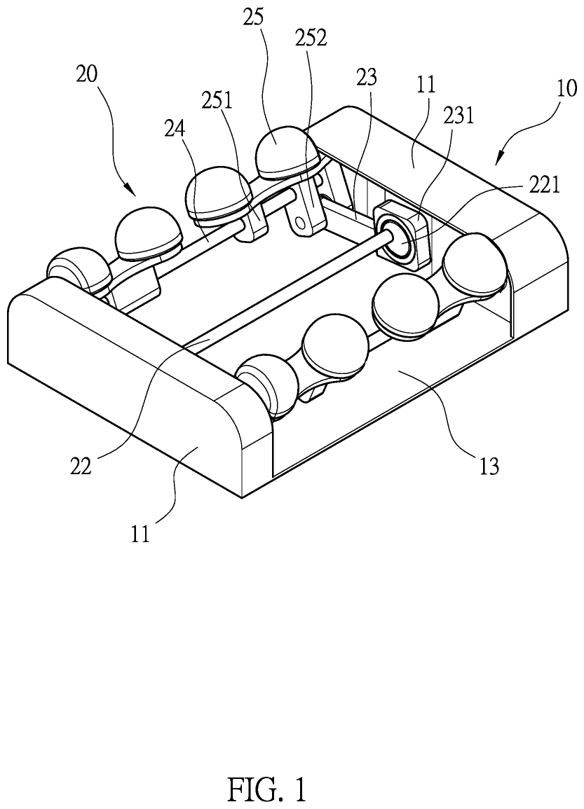

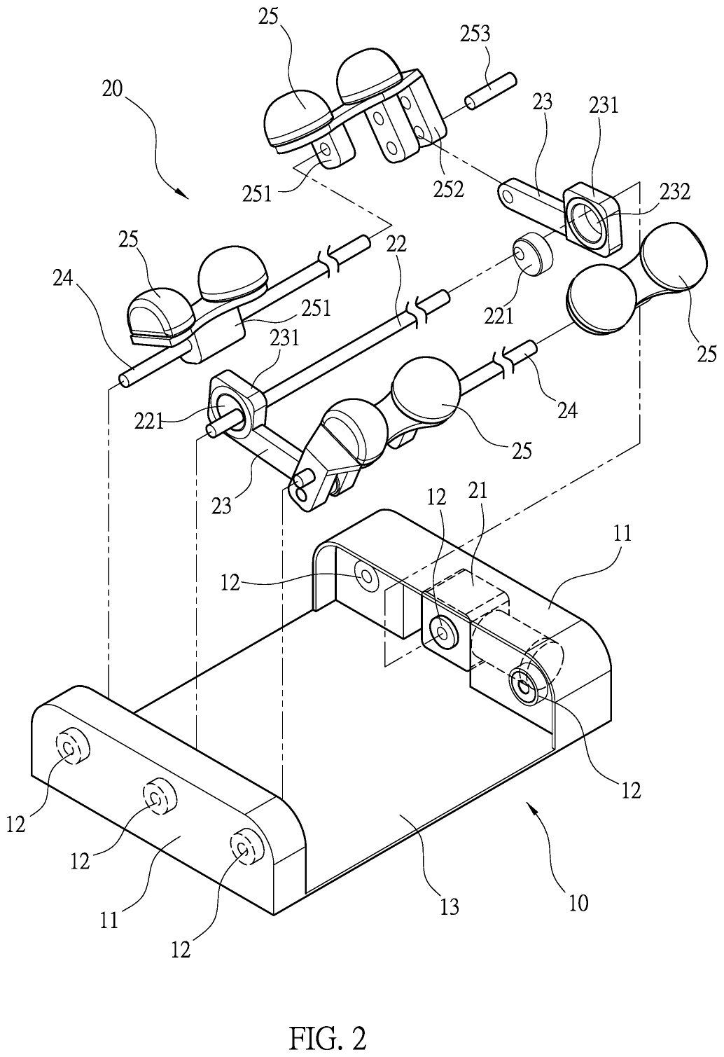

Referring to FIGS. 1 and 2, the present invention provides a multifunctional massager having a frame body (10), and two first connecting bases (11) are respectively formed at two ends of the frame body (10) at symmetrical positions. Each of the two first connecting bases (11) comprises three connecting bears (12) at the inner surface thereof, and the connecting bears (12) on the two first connecting bases (11) are located at corresponding positions, and the distance between two adjacent connecting bears (12) on the first connecting base (11) is the same. Moreover, an accommodating space (13) is formed between the two first connecting bases (11). A massage member (20) installed on the fame body (10) between the two first connecting bases (11) comprises a driving motor (21), a driving shaft (22), two connecting rods (23), and two driven shafts (24). The driving motor (21) is connected to and drives the driving shaft (22), and two eccentric wheels (221) are connected to two ends of the driving shaft (22), and the eccentric wheels (221) are located at staggered positions, so that the rotation paths of the two eccentric wheels (221) are opposite. Each of the two connecting rods (23) comprises a rotary base (231) installed at one end thereof, and each of the rotary bases (231) has a connecting hole (232) to securely connect to the eccentric wheel (221). Each of the two driven shafts (24) has a plurality of massage heads (25) secured thereon, and each of the massage heads (25) comprises a second connecting base (251), and the massage head (25) is configured to be secured on the driven shaft (24) through the second connecting base (251). Moreover, each of the two driven shafts (24) is connected to a swing arm (252) extended from the second connecting base (251) at the end of the driven shaft (24), and the two swing arms (252) are respectively located at diagonal positions on the two driven shafts (24), and each of the swing arms (252) is connected to a connecting rod (23).

In one embodiment, the two swing arms (252) are integrally formed on the ends of the two driven shafts (24) at diagonal positions.

In another embodiment, the two swing arms (252) are connected to the ends of the two driven shafts (24) at diagonal positions.

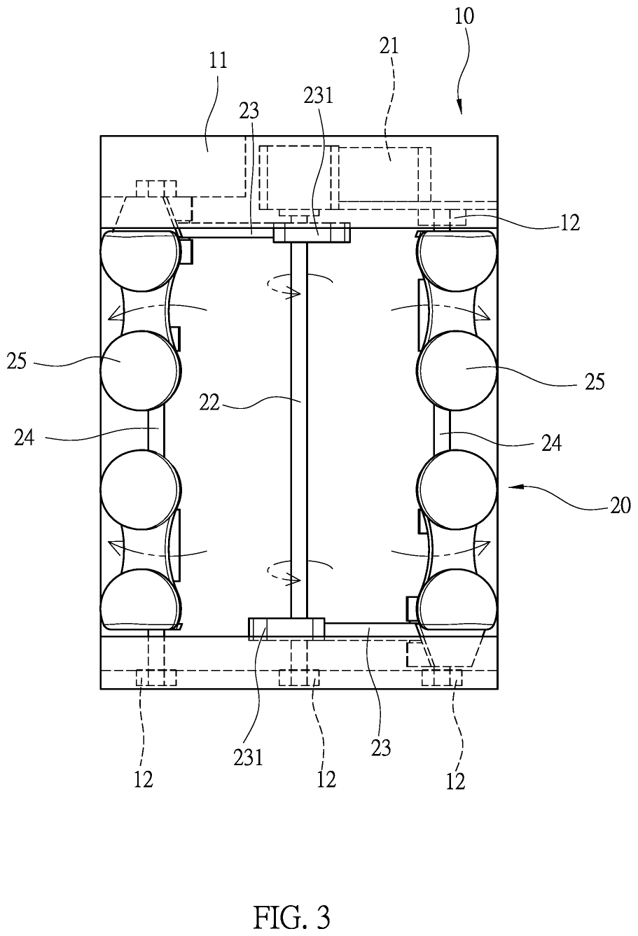

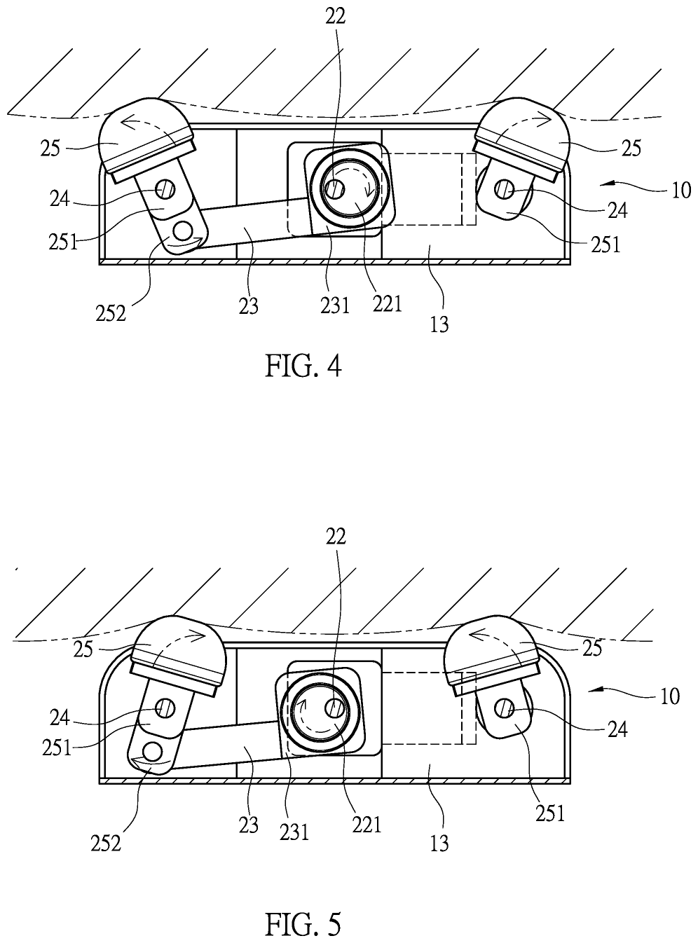

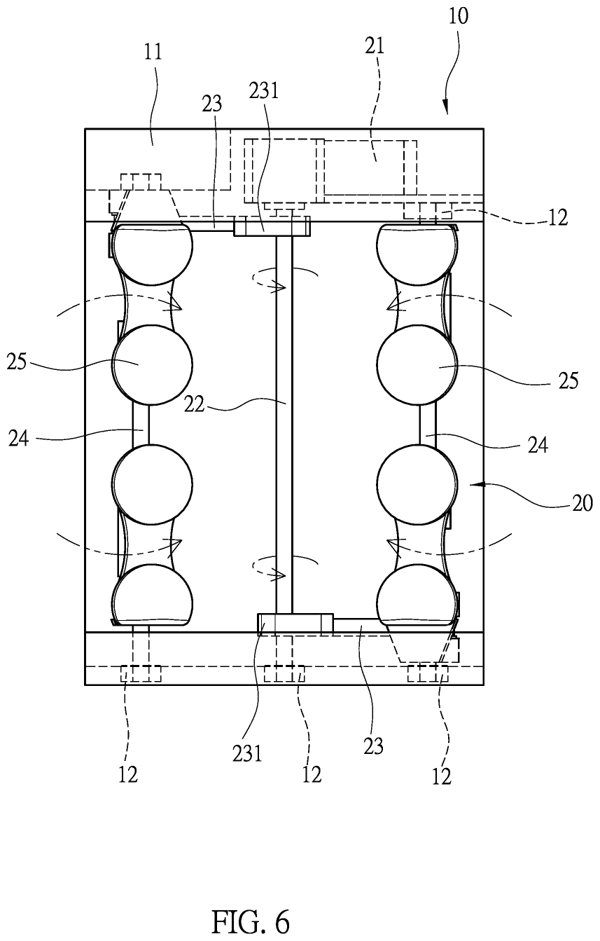

Structurally, referring to FIGS. 2 to 6, the two driven shafts (24) are positioned in parallel at two sides of the driving shaft (22), and each of the connecting rods (23) is connected to the eccentric wheel (221) of the driving shaft (22) through the connecting hole (232) of the rotary base (231), and each of the connecting rods (23) is extended outwardly to connected to one driven shaft (24). Each of the two driven shafts (24) is connected to one swing arm (252) at one end, and the swing arm (252) is connected to the connecting rod (23) through a bolt (253), and two swing arms (252) are located at diagonal positions at two ends of the frame body (10), so that the driving shaft (22) is adapted to synchronously drive the two driven shafts (24) through the connecting rods (23). The driving motor (21) connected at one end of the driving shaft (22) is located in the first connecting base (11) at the position aligned with the connecting bearing (12) at the middle while the other end of the driving shaft (22) is connected to the connecting bear (12) at the middle on the other side of the first connecting base (11). The two driven shafts (24) are connected between the two first connecting bases (11) at two sides of the driving shaft (22), and each of the driven shafts (24) is connected to the two first connecting bases (11) through two corresponding connecting bears (12) so as to install the massage member (20) in the accommodating space (13) between the first connecting bases (11). The driving motor (21) is configured to drive and rotate the driving shaft (22), and the two eccentric wheels (221) are adapted to eccentrically drive the two connecting rods (23) to carry out the reciprocating actions of internal pull and external push, and the two driven shafts (24) are driven to swing laterally so as to achieve the massage purpose through the massage heads (25).

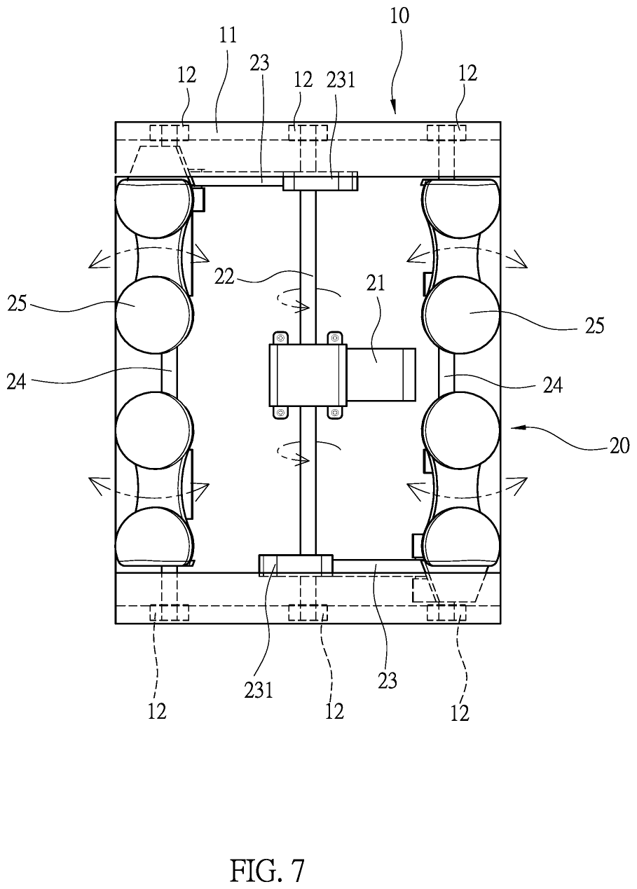

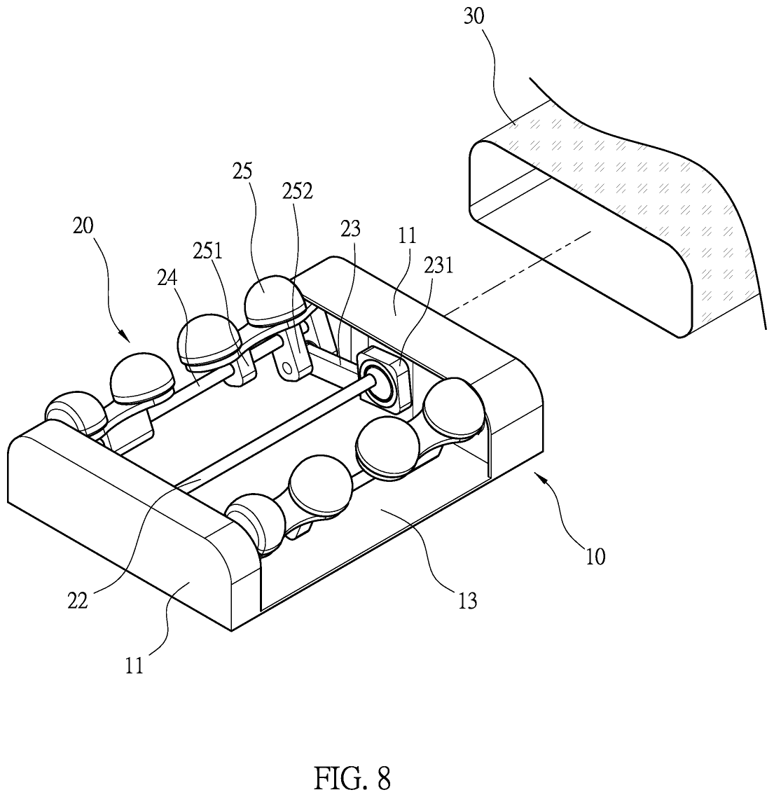

In still another embodiment, referring to FIG. 7, the driving motor (21) connected to the center portion of the driving shaft (22) is secured on the frame body (10), and the two ends of the driving shaft (22) are respectively and pivotally connected to the two connecting bears (12) at the middles of the two first connecting bases (11).

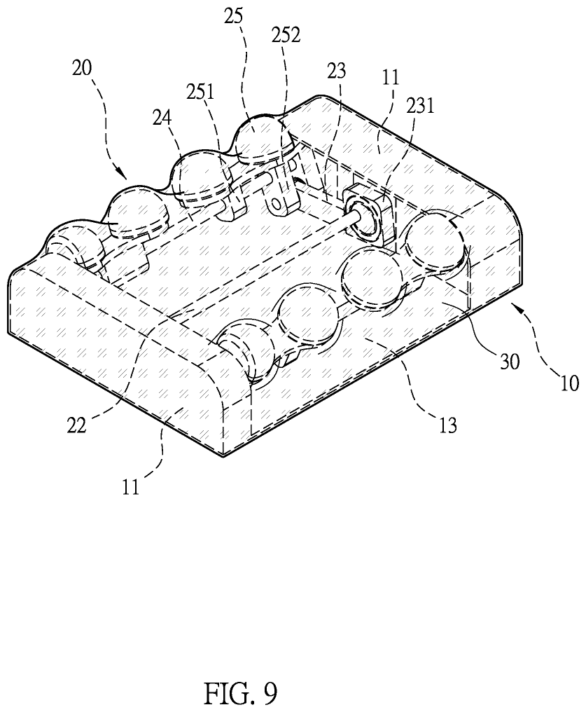

In a further embodiment, referring to FIGS. 8 and 9, a cover is adapted to cover the frame body (10) and the massage member (20).

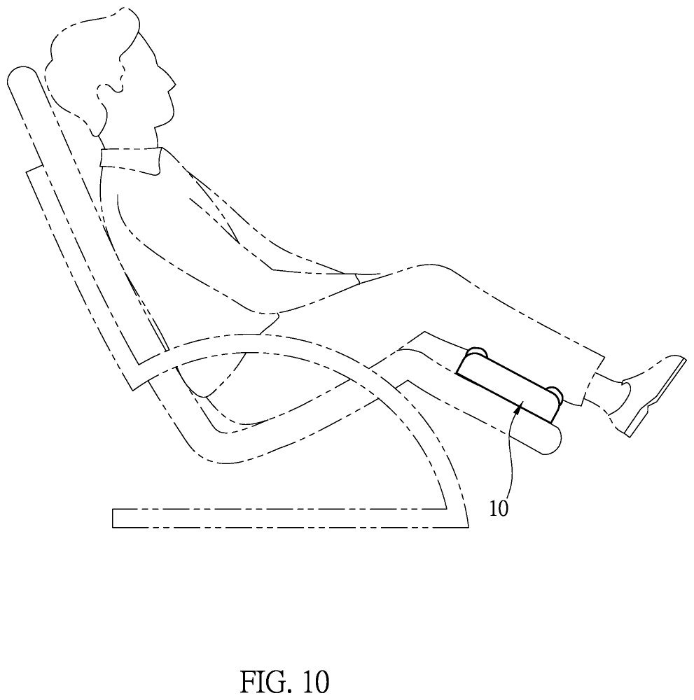

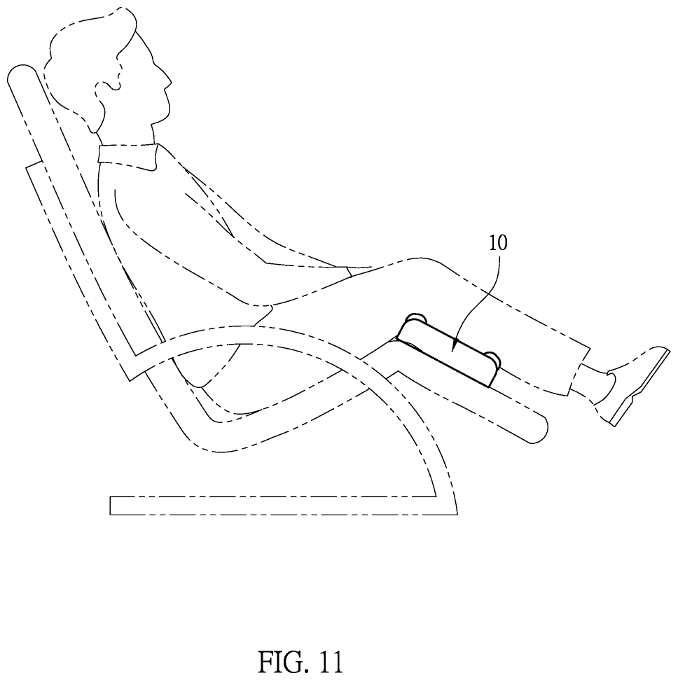

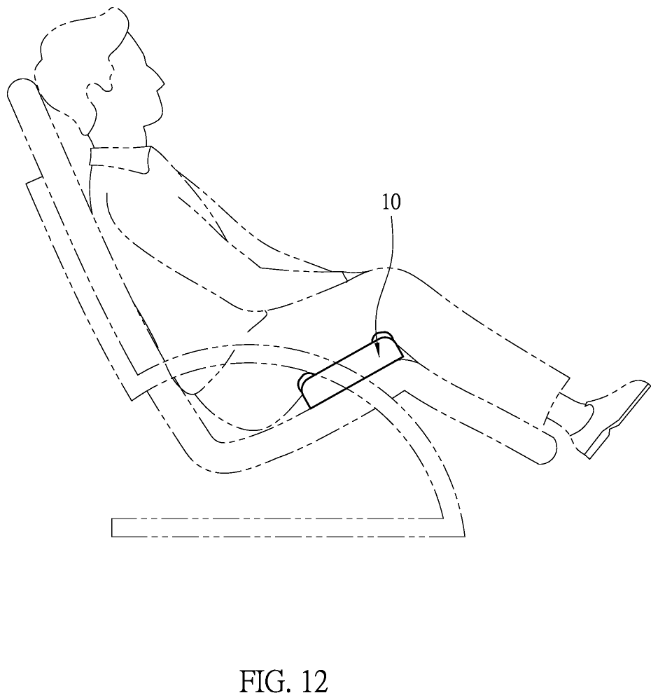

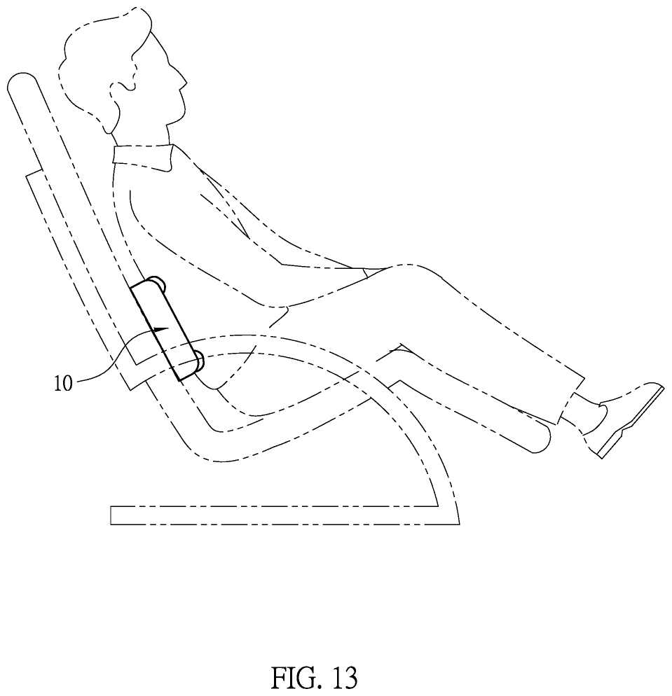

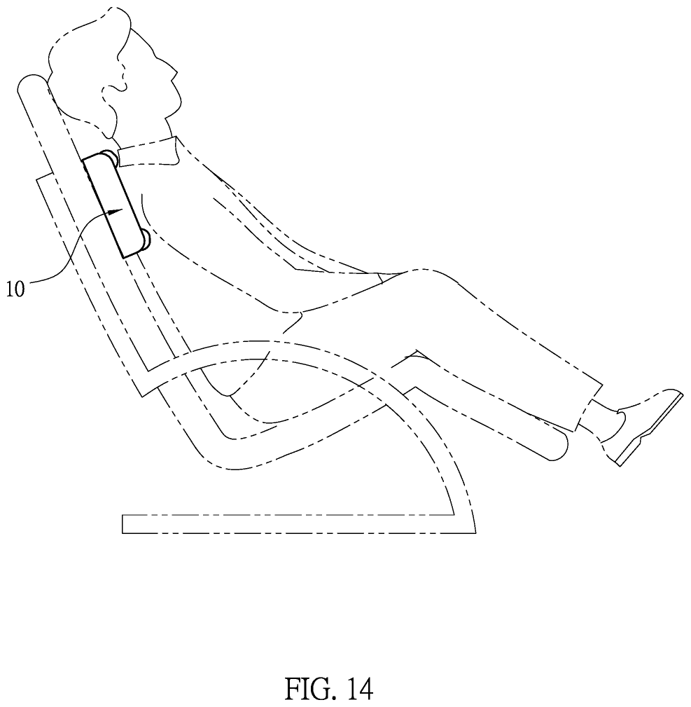

In actual application, referring to FIG. 1, the frame body (10) is in the form of a box to be placed freely on chairs, sofas, recliners and other kinds of chair tools. Referring to FIG. 10, the massager can be placed on lower portion of a reclining chair to massage the user's lower leg, and referring to FIG. 11, the massager can also be placed on mid lower portion of the reclining chair to massage the user's lower leg. Furthermore, as shown in FIG. 12, the massager can be placed on the front half of the seat of the recliner chair to massage user's thigh and hip, and referring to FIG. 13, the massager can be placed on the lower back part of the reclining chair to massage the user's waist and lower back. In addition, as shown in FIG. 14, the massager can be placed on the upper part of the seat of the reclining chair to massage the user's shoulder, neck and upper back.

Comparing with conventional multifunctional massager, the present invention is advantageous because: (i) the massager is small and portable, so that the user can change the way and position to massage the sore parts of the body without purchasing different kinds of massagers; and (ii) the driven shafts (24) connecting to the massage heads (25) are arranged at both sides of the driving shaft (22), and the reciprocating massage is carried out through the massage heads (25) such that the two driven shafts (24) have an appropriate distance therebetween to provide the preferable kneading from the massage heads (25).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A multifunctional massager comprising a frame body and a massage member;
wherein the frame body has two first connecting bases respectively formed at two ends thereof at symmetrical positions; and each of the two first connecting bases comprises three connecting bears at the inner surface thereof, and the connecting bears on the two first connecting bases are located at corresponding positions, and the distance between two adjacent connecting bears on the first connecting base is the same; an accommodating space is formed between the two first connecting bases; and
wherein the massage member installed on the fame body between the two first connecting bases comprises a driving motor, a driving shaft, two connecting rods, and two driven shafts; the driving motor is connected to and drives the driving shaft, and two eccentric wheels are connected to two ends of the driving shaft, and the eccentric wheels are located at staggered positions, so that the rotation paths of the two eccentric wheels are opposite; the two connecting rods are respectively connected to the two eccentric wheels at the ends thereof, and the two connecting rods are respectively extended outward in staggered directions; each of the two driven shafts has a plurality of massage heads secured thereon, and the two driven shafts parallel with the driving shaft are positioned at two sides of the driving shaft; each of the two driven shafts is pivotally connected to a swing arm, and the two swing arms respectively and pivotally connected to the two connecting rods are respectively located at diagonal positions on the two driven shafts; the two ends of the driving shaft are respectively and pivotally connected to the two connecting bears at the middles of the two first connecting bases, and the two driven shafts are respectively connected between the two first connecting bases through the two corresponding connecting bears at two sides of the middle of connecting bears; when the driving motor drives and rotates the driving shaft, the two eccentric wheels are adapted to eccentrically drive the two connecting rods to carry out the reciprocating actions of internal pull and external push, and the two driven shafts are driven to have relative swing so as to achieve the massage purpose through the massage heads.

2. The multifunctional massager of claim 1, wherein the driving motor connected at one end of the driving shaft is located in the first connecting base at the position aligned with the connecting bearing at the middle.

3. The multifunctional massager of claim 1, wherein the driving motor connected at the middle of the driving shaft is secured on the frame body.

4. The multifunctional massager of claim 1, wherein each of the two connecting rods comprises a rotary base installed at one end thereof, and each of the rotary bases has a connecting hole to securely connect to the eccentric wheel.

5. The multifunctional massager of claim 1, wherein each of the massage heads comprises a second connecting base, and the massage head is secured on the driven shaft through the second connecting base; each of the two driven shafts is connected to the swing arm extended from the second connecting base at the end of the driven shaft, and the two swing arms are respectively located at diagonal positions on the two driven shafts.

6. The multifunctional massager of claim 1, wherein the two swing arms are respectively installed on the ends of the two driven shafts at diagonal positions.

7. The multifunctional massager of claim 1, wherein a cover is adapted to cover the frame body and the massage member.
